(19) United States
(12) Patent Application Publication
(10) Pub. No.: US 2012/0025516 A1
(43) Pub. Date: Feb. 2, 2012

(54) Secure Lottery Ticket Using Hybrid Construction

(76) Inventors: William John Miller, Lithia, FL (US); Michael Francis Dinan, Lithia, FL (US)

(21) Appl. No.: 13/049,719

(22) Filed: Mar. 16, 2011

Related U.S. Application Data
(60) Provisional application No. 61/368,109, filed on Jul. 27, 2010.

(51) Int. Cl. B42D 15/00

(52) U.S. Cl. 283/100

(57) ABSTRACT

Solvent-based and water-based scratch-off materials are employed as single layers on a lottery ticket to create a more resistant ticket construction that still provides a satisfactory play experience. In one embodiment, two different scratch-off inks on the play area of the ticket are employed, with the majority of the ink being a softer, solvent-based, formulation. The ink covering sensitive areas of the ticket includes a harder, water-based, formulation.

### REFERENCE TO RELATED APPLICATIONS

The present application claims the benefit of U.S. Application No. 61/368,109, entitled “Secure Lottery Ticket Using Hybrid Construction” filed on Jul. 27, 2010.

### FIELD OF THE INVENTION

The present invention pertains to the structure of documents with scratch-off coatings, and more particularly to a device and method for preventing fraud or attack on documents with scratch-off coatings.

### BACKGROUND

Various types of documents employ scratch-off coatings. For example, lottery tickets, game cards, coupons, vouchers and other documents employ scratch-off coatings in order to cover indicia that can be revealed according to the particular rules and methods of operation involved. The overall card structure typically includes a substrate such as paper stock of sufficient thickness, indicia printed or imaged on the substrate, a release coating to protect the indicia from being scratched of while providing a proper surface for securing a scratch-off layer, a scratch-off material to conceal the indicia, and a graphic overprint layer to provide desired design effects.

In the context of games and lottery tickets, the indicia on each ticket typically include ticket identification data, game indicia and a validation number, for example. Ticket identification data typically comprises a game number, pack number and ticket number. The game number corresponds to the lottery game involved, the pack number corresponds to the pack of tickets printed as part of the game, and the ticket number corresponds to the particular ticket's number within the given pack. The game indicia comprises variable game numbers, letters, designs or other indicia that indicate whether the player is a winner as a result of playing the ticket. The validation number assists in reducing fraud such as where the ticket has been altered prior to redemption. The validation number uniquely identifies the lottery ticket, and therefore the game indicia on that particular ticket, so that a lottery administrator can verify that the ticket is a winner during the redemption process. In most instances, the validation number is encrypted.

In addition to the above indicia, the ticket can include a barcode representing the ticket identification data and validation number. The barcode is typically provided on the back of the ticket and is typically not covered by scratch-off material.

The indicia on each ticket, including the barcode, is typically generated by one or more computer programs and can be printed/imaged on each ticket as part of the ticket construction process. In some cases, the ticket's value can be directly determined if one knows the ticket identification data or the validation number. In other cases, an additional process must be undertaken, such as entering the data into a computer program, for example, in order to determine the ticket's value. In either case, the ticket is much more susceptible to compromise if the ticket identification data or validation number is known. This is why the validation number is placed under a scratch-off layer. In fact, the validation number is often called the “void-if-removed number” or “VIRN number” because it is intended to remain under the scratch-off layer until the time of ticket redemption, and the ticket is voidable if the validation number has been revealed prior to redemption.

The scratch-off coating hides the ticket identification data, game indicia and the validation number. The scratch-off material can be any of a number of substances, but frequently is an opaque material comprised of an elastomeric compound of a solvent- or water-based acrylic resin. When the resin is applied, the solvent or water evaporates and the opaque resin remains in place above the indicia. Prior ticket structures with scratch-off coatings are disclosed, for example, in U.S. Pat. Nos. 5,215,576; 5,569,512; 5,667,250 and 6,047,964.

Because scratch-off coatings hide material that indicates whether the ticket has any value as described above, unscrupulous individuals have devised ways of discovering the underlying information without noticeably marking the ticket itself. As a result, any winning tickets can be hoarded by such individuals while losing tickets are left to be sold to the unsuspecting public.

There are many common methods of fraud or attack on well constructed lottery tickets. Two, in particular, have been successfully used to compromise scratch-off tickets prior to sale.

The first method is known as tape lift. In this method, clear adhesive tape is applied to the surface of the ticket and pulled up. This may remove sufficient amounts of the scratch-off coating so as to reveal important information about the ticket. This is commonly done by employees of retailers in an effort to pick winners out of the inventory of tickets on hand. After the lift has been made and the necessary data obtained, an attempt is made to validate the ticket. If validation succeeds, the ticket will be put aside for later redemption. If validation fails, the tape will be put back down and usually left in place. A razor knife will be used to make many small cuts in the remaining tape so that if that area is scratched, the pieces will flake off, similar to what happens when the scratch coating is scratched off in undamaged tickets.

In order to defeat the tape lift method, water-based scratch-off coatings have been used. Such coatings are more resistant to the tape lift attack than traditional solvent-based coatings. Nevertheless, water-based coatings tend to be dusty and somewhat harder to scratch than traditional solvent-based coatings, leading to an unsatisfactory play experience.

The second method of attack is known as mechanical lift. Mechanical lift involves a razor blade or other similarly sharpened surface, which is carefully positioned under the scratch layer in order to lift up a small flap. The individual using the blade may choose to reveal either the VIRN number or the captions of the play symbols, which represent a small lift area. After the data has been read, the flaps are glued back down with a water-soluble glue. This method of compromise depends on maintaining the integrity of the flap that is lifted so that it can be re-affixed easily. Water-based scratch-off coatings can be employed to combat mechanical lift, but have the same disadvantages outlined above.

### SUMMARY OF THE PRESENT INVENTION

The present invention combines the best of both solvent-based and water-based scratch-off materials to create a more resistant ticket construction that still provides a satisfactory play experience. In one embodiment, two different scratch-off inks on the play area of the ticket are employed, with the majority of the ink being a softer, solvent-based, formulation. The ink covering sensitive areas of the ticket includes a harder, water-based, formulation. If tape is applied to sensitive areas of the ticket in an attempt to compromise the validation number or other valuable pieces of data, the different areas will react so as to indicate the existence of a tampering attempt.

For the purposes of the present disclosure, it will be appreciated that “solvent-based” elastomeric compound means a compound or an ink that is carried in a solvent, whereas “water-based” ink means an ink that is carried in water. Specifics of both printing materials are described, for example, in U.S. Pat. No. 5,215,576 to Carrick, which is incorporated herein by reference in its entirety. It will further be appreciated that “printing” can mean traditional printing as well as imaging, for purposes of the present disclosure.

In one embodiment of the present invention, solvent-based and water-based scratch-off materials are provided so as to comprise a single ticket layer, albeit of different materials in discrete sections of the ticket surface. While computer programming is not required for operation of the present invention, suitable computer programming associated with the present invention permits printing in a highly exact manner with tight registration so as to assist in minimizing overlap and blank space between the different materials in the single layer embodiment. In another embodiment of the present invention, solvent-based and water-based scratch-off materials are provided so as to comprise two single ticket layers, one on top of the other, wherein each layer includes a portion that is solvent-based and a portion that is water-based, with no or minimal overlap or blank space therebetween on the surface of the ticket. In the dual layer embodiment of the present invention, it will be appreciated that the solvent-based scratch-off material on the top layer is directly atop the solvent-based scratch-off material on the bottom layer, and the water-based scratch-off material on the top layer is directly atop the water-based scratch-off material on the bottom layer.

### BRIEF DESCRIPTION OF THE DRAWINGS

FIG. 1 is a front view of a ticket such as may be used in accordance with the present invention.

FIG. 2 shows the ticket of FIG. 1 with highlighted areas illustrating potential locations for a hidden VIRN number.

FIG. 3 is an exploded perspective view of one embodiment of the present invention.

FIG. 4 is a schematic cross-sectional view taken along the line 4-4 of FIG. 3.

FIGS. 5A-5D, 6A-6D and 7A-7D illustrate examples of play areas from a series of tickets that can be printed in accordance with the present invention.

### DETAILED DESCRIPTION OF EMBODIMENTS OF THE PRESENT INVENTION

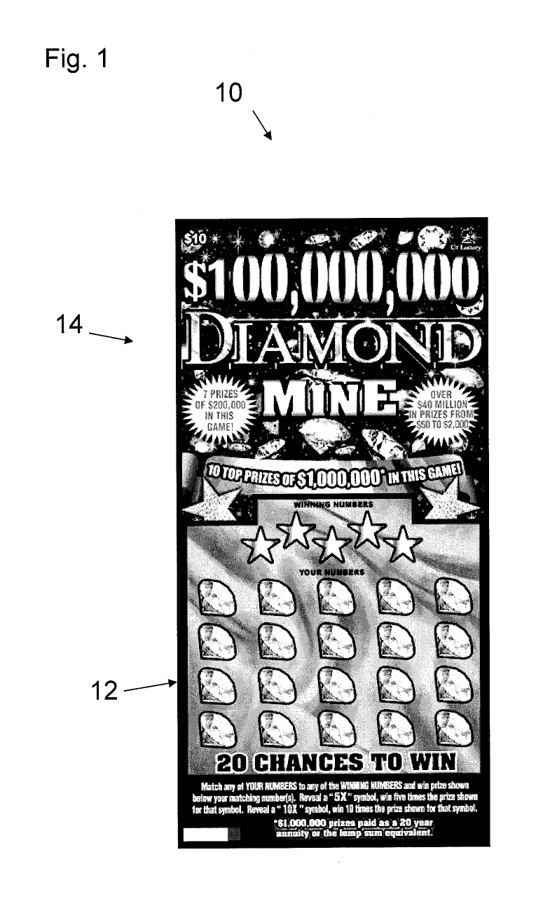

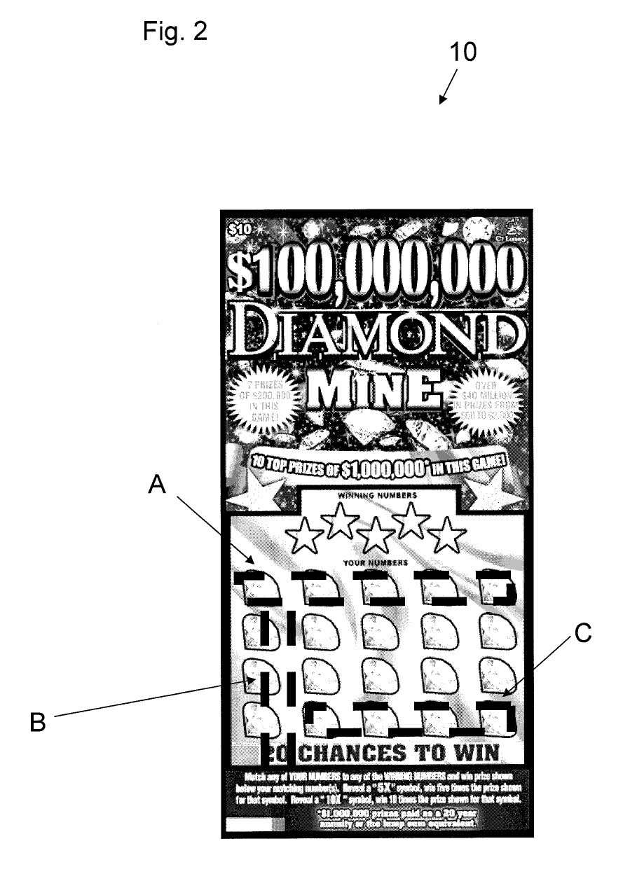

FIG. 1 shows a ticket 10 having a play area 12 and a design area 14. FIG. 2 shows dashed line boxes A, B and C that illustrate different regions within the play area where a VIRN number may be concealed under the surface coating in accordance with the present invention. During the printing process, the tickets may go through a single printer or a series of printers in order to apply different elements to the ticket.

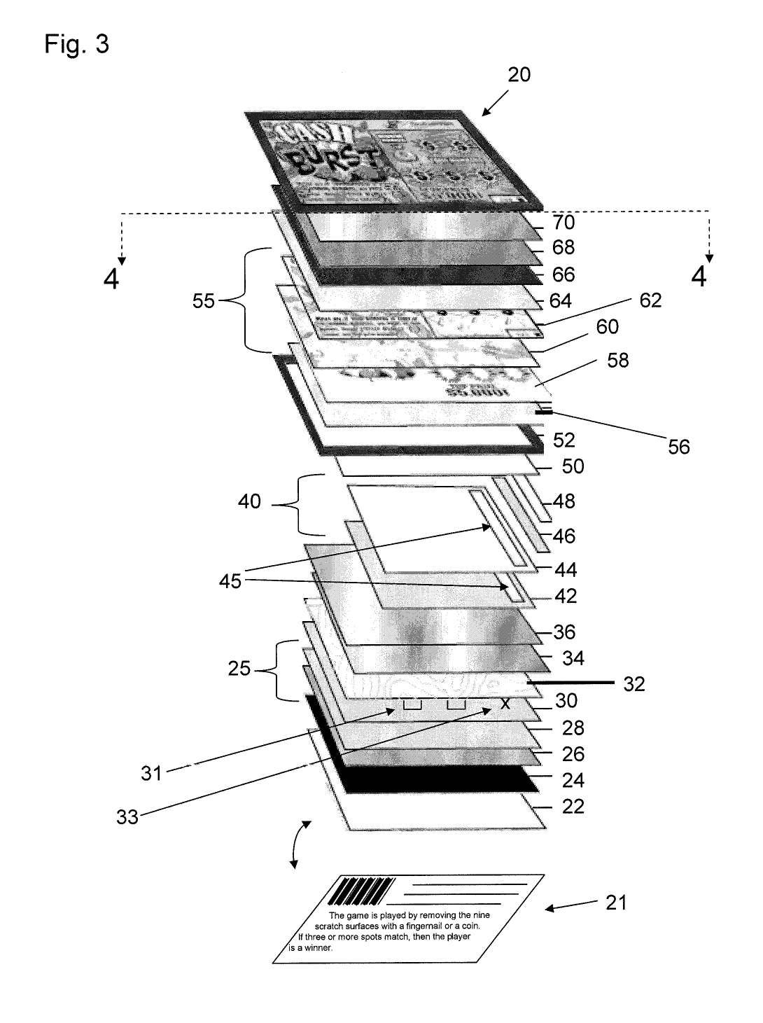

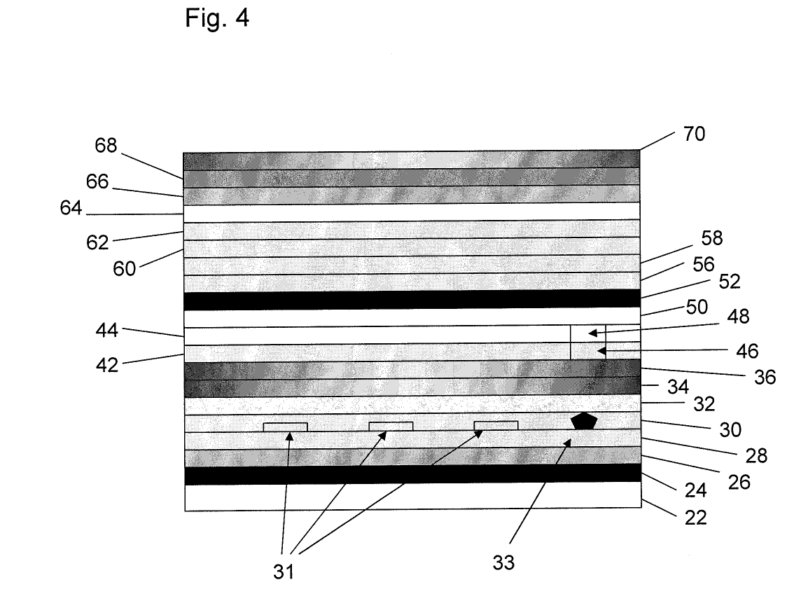

FIGS. 3 and 4 illustrate different layers that can be applied to a ticket to achieve the results of the present invention. For purposes of the present disclosure, it will be appreciated that the term “layer” means a substantially planar application of whatever specific material or combinations of material comprise the layer. While it is possible that any layer will not necessarily be perfectly planar or perfectly smooth, in most cases, it should be substantially planar so as to facilitate proper ticket structure and appearance. It will be appreciated that FIG. 4 is not drawn to scale, and that there may be elements of each layer (e.g., variable game data layer 30) that do not result in an even top planar surface after being applied, despite the schematic representation in FIG. 4.

As shown in FIGS. 3 and 4, the ticket 20 comprises a substrate 22, onto which a generally light-colored ink (i.e., “lily pad”) layer 28 is provided in order to yield a suitable background against which the later-applied game indicia can be easily read. While the lily pad layer ink can conceivably be of any color, a white, pink, light blue or similar light-colored ink can work very well for the stated purposes. The ticket stock and/or substrate 22 can be cardboard, paper, foil, coated board or other material known to be applied to game card/lottery ticket type applications. The substrate can be colored or can have a colored layer applied thereto. Additionally, suitable information can be provided on the back 21 of the ticket in accordance with the game and rules of play involved. In the embodiment of the present invention where paper tickets are employed, a lower blocking background layer 24 and a lower lily pad layer 26 can be provided in addition to lily pad layer 28. Layer 28 and/or layers 24, 26, 28 comprise the base layer 25, and this layer can cover the entire ticket 20, or just the game play area of the ticket 20. The base layer 25 is formulated and applied so as to create resistance to known optical, magnetic, chemical, physical, electrical and other forms of security compromise techniques and to provide a surface suitable for receiving the variable game data layer 30. The base layer 25 can include metals such as aluminum, copper, iron oxide, carbon black, titanium dioxide, water soluble or solvent soluble dyes or inks, and a wide range of resins, for example. It is typically applied through flexographic printing but can also be applied by any suitable printing technology. The base layer 25 can be integral with the substrate 22, or can be applied as a separate layer atop the substrate 22.

The variable game data layer 30 (i.e., indicia layer) is applied atop the base layer 25, and can be printed to the ticket using printing technology such as, for example, ink jet printing (water-based or solvent-based), flexographic printing, toner-based imagers or any other suitable printing technology. As described above, the variable game data can comprise indicia such as the game indicia, ticket identification data and validation number, for example.

In one embodiment of the present invention, a benday pattern layer 32 is provided atop the game data layer 30. In another embodiment of the present invention, the benday pattern layer 32 is applied atop the base layer 25, and then the variable game data layer 30 is applied. In still another embodiment of the present invention, different printing heads or different sets of printing heads can be operated at the same time to produce a benday layer 32 at substantially the same time as the variable game data layer 30, both of which are provided atop the base layer 25. Benday patterns are well-known in the ticket printing field as providing patterns that help prevent ticket tampering. If, for example, a benday pattern on a first ticket is different from a benday pattern on a second ticket, then an unscrupulous individual who attempts to “split” the first ticket by removing a portion of that ticket and applying it to the second ticket will fail, because the benday patterns will not align.

As further shown in the embodiment of the ticket of the present invention shown in FIGS. 3 and 4, a seal coat layer 34 and a varnish layer 36 are provided atop the benday pattern layer 32. The seal coat layer 34 provides a barrier to seal and protect the variable game data in layer 30. The varnish or release layer 36 provides a layer from which the later-applied scratch-off material can be easily removed without damaging the ticket or game indicia underneath. The seal coat 34 and varnish 36 layers also guard against physical, thermal, or chemical tampering. It will be appreciated that the seal coat layer 34 and varnish layer 36 can comprise a single layer or more than one layer. They may also be tinted, transparent, translucent or clear. They may be solvent based, water-based or UV-curable, which are dried using combinations of heat energy and air turbulence. The layers 34, 36 can be designed so as to be cured using various forms of radiation such as electron beam or ultraviolet radiation. As such, the well known chemical formulations of the materials vary widely and may include vinyl chloride resins, polyamide resins, silicone, monomers, oligomers, waxes, benzophenone, anti-foaming agents, photo-initiators and colorants.

As further shown in FIGS. 3 and 4, the next layers applied to the ticket are solvent-based scratch-off material and water-based scratch off material, and these materials are applied to different sections of the ticket in order to obtain the advantages of the present invention. These materials typically contain synthetic rubbers, and the opaque versions typically contain metals such as aluminum, copper, bronze, carbon black, graphite, or any other materials that create the necessary opaque elastomeric characteristic of a scratch-off coating. The scratch-off layer(s) can be used to absorb solvents and resist many known forms of decoding including electrostatic, X-ray, chemical, thermal, adhesive, high voltage static electricity, vapor and a wide range of physical forms of attack such as lifting, pinpricking and the like.

The scratch-off material layer 40 resides atop layers 34, 36. Scratch-off layer 40 can include a solvent-based black or opaque scratch-off material layer 42, and a solvent-based white scratch-off material layer 44. It will be appreciated that the white layer can actually comprise an off-white color or other lighter color instead of white, depending upon the application and the intended effect; however, for purposes of the present disclosure, it will be referred to as a white layer herein. As shown in FIGS. 3 and 4, the opaque and white solvent-based layers are printed with at least one open or vacant area 45. The vacant area 45 is intentionally omitted when printing the solvent-based scratch materials, and intentionally aligned with the underlying validation number 33 printed as part of the variable game data layer 30. The underlying scratch-off material 42 is black or opaque so as to cloak the material contained below, and the overlying layer 44 is white so as to provide a background from which later-added design colors will be appropriately viewable. Layers 42 and 44 are applied atop the game indicia, and not atop the VIRN 33 or, in one embodiment of the present invention, any other information used to authenticate the ticket (e.g., captions, bonus areas, player's key, etc.). The vacant area is shown as a contiguous area in FIG. 3, but it will be appreciated that the present invention contemplates that more than one area can be left vacant when applying the solvent-based scratch-off material.

Within the vacant areas 45 in the solvent-based scratch layers 42, 44, water-based scratch-off material layers 46, 48 are provided. In one embodiment of the present invention, as with the solvent-based layers 42 and 44, the underlying water-based scratch-off layer 46 is opaque and the overlying water-based scratch-off layer 48 is white. These layers 46, 48 are applied to the vacant areas where the solvent-based layers 42, 44 are not applied, coinciding with the areas where authentication information is positioned on the ticket. These layers 46, 48 can be applied in separate printing steps and give the physical and visual appearance of a single continuous layer when combined with the solvent-based scratch-off layers 42, 44. In one embodiment of the present invention, layers 42 and 46 comprise a single layer with a substantially horizontal top planar surface as illustrated in FIG. 4, for example. In another embodiment of the present invention, layers 44 and 48 comprise a second single layer with a substantially horizontal top planar surface as illustrated in FIG. 4, for example.

Layers 42, 44, 46 and 48 can be applied, for example, by a flexographic printing technique in which the coating or ink is applied to a relatively pliable printing head and transferred by the head to the ticket. The ink can also be applied by rotogravure or other printing techniques, such as, for example, by application of silk screen technology.

The sequence of applying layers 42 and 44 as compared to applying layers 46 and 48 is not necessarily important. However, each layer can be applied in separate printing steps. As a result, four printing steps can be used to apply two complete layers of scratch-off material, with each individual layer comprising part solvent-based scratch-off material and part water-based scratch-off material. For example, the four printing steps can be performed such that the lower, opaque, solvent-based scratch-off material is applied first, followed by the lower, opaque, water-based scratch-off material, followed by the upper white solvent-based scratch-off material, and finally by the upper white water-based scratch-off material. Alternatively, the two solvent-based scratch-off materials can be applied first, followed by the two water-based scratch-off materials. As described above, it will be appreciated that the order of printing the different layers and material types is not considered critical to the present invention, and that any preferred ordering of steps can be employed.

In one embodiment of the present invention, suitable software programming stored in the memory of a computer and executed by a processor associated with the computer can direct the printing press to apply the scratch-off materials in a highly exact manner with tight registration such that the solvent-based scratch-off ink and the water-based scratch-off ink substantially abut one another without bleeding into one another. In this way, there is no or very minimal overlap as between the different materials. Overlapping materials are an undesired consequence of applying the different scratch-off materials together in single layers, since it can be visually or physically obvious where the two different materials intersect, thereby tipping off a potentially unscrupulous individual as to where the validation number resides on the ticket. The software programming can also apply the scratch-off materials such that there is no blank space in between the different scratch-off materials. Any blank space can also tip off an unscrupulous individual as to where the materials were intended to intersect, thereby indicating the location of the validation number.

It will be appreciated that, during construction of a ticket in accordance with the present invention, the vacant areas in the solvent-based scratch layers can be moved to different locations on the ticket so as to correspond with the location of the sensitive underlying data such as the validation number, for example. In one embodiment of the present invention, batches of tickets can be run with the VIRN number and/or other authentication information extending horizontally across the top section of the location on the ticket where indicia are applied. Separate batches can be run with the VIRN number and/or other authentication information extending vertically in a different area of the ticket where indicia are applied. In each case, at least one of the vacant areas of the solvent-based scratch-off material would lie directly above the VIRN number and/or other sensitive information on the ticket. This “moving” or “floating” authentication information reduces the predictability of location for this important information, which can help deter and/or thwart unscrupulous individuals who might seek to compromise the integrity of the ticket. As an alternative to hatch printing, the floating VIRN can change location on a ticket-by-ticket basis as programmed or directed by the operator of the printing press.

While the vacant areas are shown in FIG. 3 as being substantially rectangular-shaped bands, it will be appreciated that neither the shape nor location of the vacant areas is limited. In one embodiment of the present invention, the location of the underlying authentication data is randomized on a per-ticket basis. In another embodiment of the present invention, the location of the underlying authentication data is changed in batches, such that the printing of the layers 42, 44, 46 and 48 does not necessarily need to be changed on a ticket-by-ticket basis, but can be changed on a ticket batch basis.

It will further be appreciated that, in one embodiment of the present invention, the water-based scratch-off material can be applied in more than one area, even if only one location is above the VIRN number and/or other authentication information. In this way, if an effort is made to compromise the ticket based upon finding an area of the ticket that provides a dustier, less desirable scratching experience as is generally associated with water-based scratch-off materials, the unscrupulous individual seeking to compromise the ticket may not necessarily find validation information lying underneath. As such, the present invention facilitates the generation of “false leads” as an added element of security. While additional water-based scratch-off areas may help generate false leads, it will be appreciated that it is desirable to leave any game indicia underneath the solvent-based scratch-off material so as not to compromise the game play experience for the ticket holder.

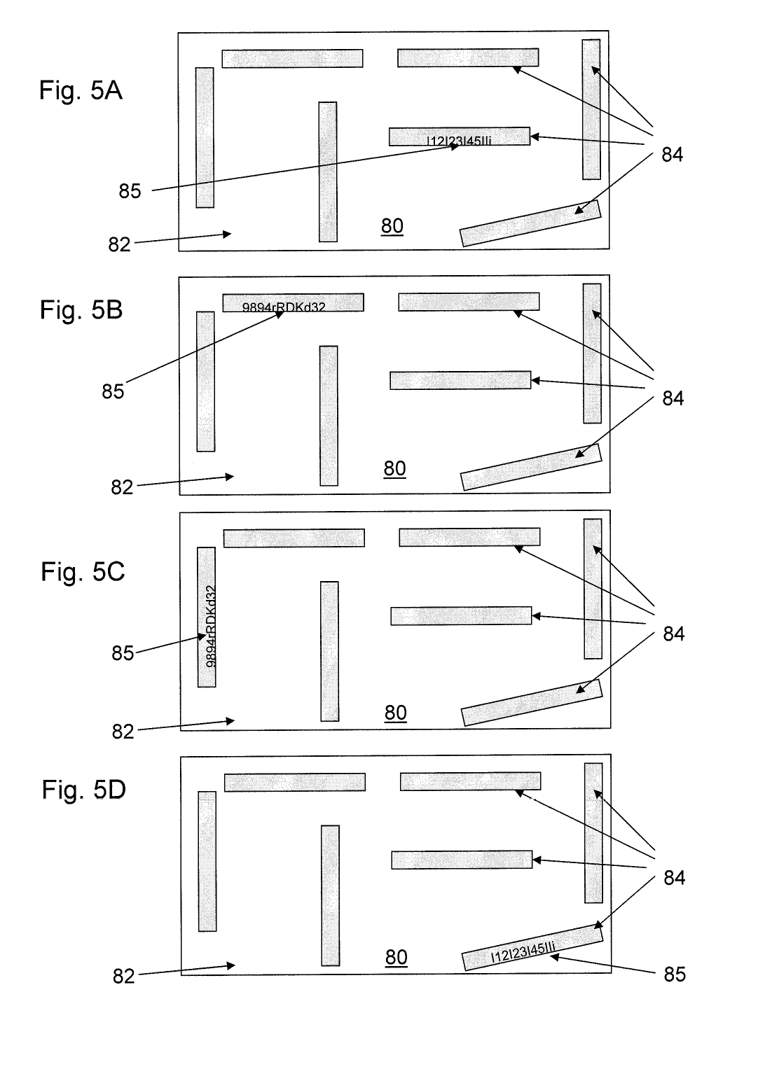

FIGS. 5A-5D, 6A-6D and 7A-717 illustrate examples of play areas from different series of tickets that can be printed in accordance with the present invention. The game play indicia are not shown in these figures, but would be present in the play area as will be well understood to those skilled in the art. As shown in FIGS. 5A-5D, each play area 80 of the four tickets in the series includes a portion provided with solvent-based scratch material 82 and portions provided with water-based scratch material 84. The water-based scratch material 84 is shown in the same seven locations on the play area 80 of each ticket, while the validation number 85 is shown under only one of the locations of the water-based material.

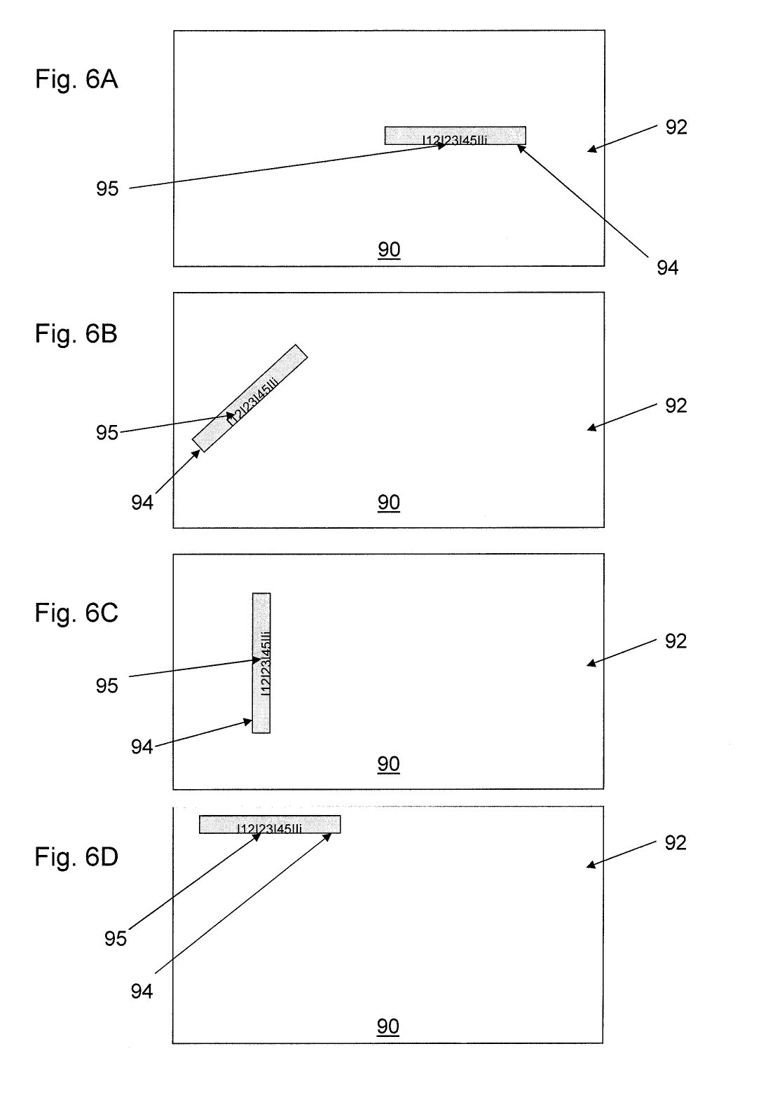

As shown in FIGS. 6A-6D, each play area 90 of the four tickets in the series similarly includes a portion provided with solvent-based scratch material 92 but only a single portion provided with water-based scratch material 94. While the water-based scratch material 94 and underlying validation number 95 float around from location to location on a given ticket, there is no extra water-based material to serve as a possible false lead. As such, the arrangement in FIGS. 6A-6D may be less secure than the arrangement shown in FIGS. 5A-5D.

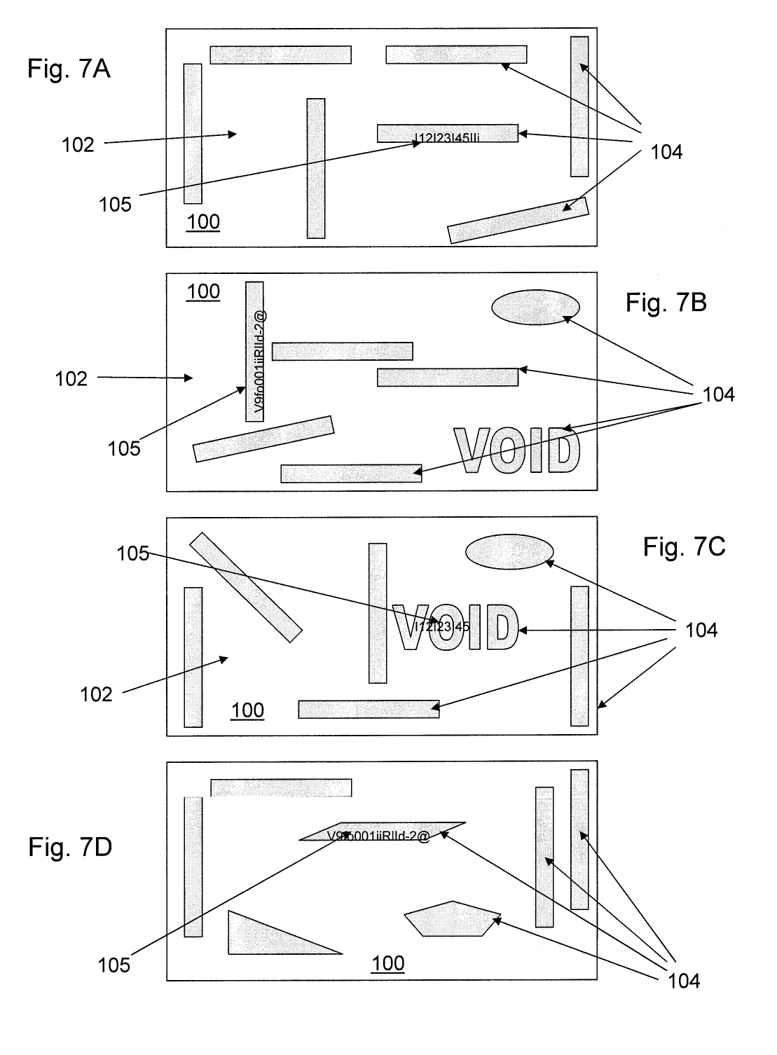

As shown in FIGS. 7A-7D, multiple differently shaped water-based scratch material elements 104 are provided in the play area 100 of each of the four tickets in the series shown, along with solvent-based scratch material 102. The seven water-based scratch material elements differ in location and shape from ticket to ticket. Additionally, the validation number 105 is shown in different locations on each ticket, and under differently shaped elements 104. As shown in FIG. 7C, the validation number 105 is under the word VOID formed as one of the water-based scratch elements 104. In FIGS. 7B and 7D, the same word VOID appears as one of the water-based scratch elements 104; however, the validation number 105 does not appear thereunder. It will be appreciated that the word VOID is but one example of a water-based scratch element that is not a geometric shape. Other words, numbers, alphanumeric combinations, designs and symbols can also be used.

With reference back to FIGS. 3 and 4, a white overprint ink layer 50 can be applied atop the layers 42, 44, 46 and 48. This layer further assists in providing a suitable background for later applied color and/or design layer(s). Pantone Matching System (PMS) bleed layer 52 can be applied atop the overprint layer 50, followed by a suitable graphic printing process. In one embodiment of the present invention, a four-color process front screen and/or graphic overprint layer 55 is employed, comprising layers of yellow 56, magenta 58, cyan 60 and black 62 as are commonly used and applied in the lottery ticket printing field. In other embodiments, the present invention can employ six-color or seven-color process printing, or even digital printing processes. The graphic overprint 55 can be applied to only the game play area of the ticket or, alternatively, to both the game play area and the design area. In one embodiment of the present invention, the graphic overprint is provided in a single offset lithographic printing process, such as that described in U.S. Application Publication No. 20100218693, of common assignee herewith, the disclosure of which is incorporated by reference herein in its entirety.

Similar color layers can also be applied to the background of the ticket in a further printing step or steps. As shown in FIGS. 3 and 4, these layers include a yellow process color layer 64, a magenta process color layer 66 and a cyan process color layer 68. Lastly, a top coat varnish layer 70 can be applied to provide further protection and stability to the ticket 20.

In one embodiment of the present invention, a design, shape, word (e.g., “VOID”) or some other security pattern can be formed from the two different scratch-off materials and placed onto the ticket. Thus, if a tampering attempt is made using tape or other means, the differential scratch characteristics of the letters will give evidence of such an attempt. In one embodiment of the present invention, as described above and shown in FIGS. 7B-7D, for example, the word “VOID” or some other word or pattern can be printed so as to cover just a portion, and less than the entire amount, of the validation data.

The present invention is not limited to water-based and solvent-based materials but may use any scratch materials where there is a difference in hardness, texture, adhesion, and other critical properties. In one embodiment of the present invention, two or more release coats having different release properties are provided as an alternative to different scratch materials. The example materials for the different release coats are described above, and the different release coats can be applied so as to comprise a single layer, in a manner similar to that described above with respect to the scratch-off layer comprised of two different scratch-off materials. For example, a first release coat may have a release characteristic that is smooth and results in a unitary body of material released from the ticket when scratched, while a second release coat can be provided that has a more granular release characteristic. Additionally, the security features of the present invention can require a printing process having more printers than typically required in past ticket printing efforts.

While the present invention can use one or more computers connected to one or more printers, it will be appreciated that the present invention can also be used with older printing presses that lack automation and/or computer driven printers, as long as the registration of the different material types is sufficiently tight. In those embodiments of the present invention that employ a computer, it will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The device of the present invention also may be embodied in a computer program product, such as a diskette or other recording medium, for use with any suitable data processing system. The present invention can further run on a variety of operating platforms. The present invention can further be operated using multiple computers and/or computer systems communicating over a network, which may be a local area network, wide area network, private or public network, such as the Internet, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A ticket, comprising:
a subtrate having indicia thereon;
a solvent-based scratch-off material applied atop at least a portion of the indicia; and
a water-based scratch-off material applied atop at least a portion of the indicia.

2. The ticket of claim 1, wherein the indicia include at least game data and validation information, and wherein the solvent-based scratch-off material is applied atop at least a portion of the game data, and further wherein the water-based scratch-off material is applied atop at least a portion of the validation information.

3. The ticket of claim 1, wherein the solvent-based scratch-off material and the water-based scratch-off material comprise a single layer on the ticket.

4. The ticket of claim 1, wherein the solvent-based scratch-off material and the water-based scratch-off material substantially abut one another without bleeding into one another.

5. The ticket of claim 1, wherein the solvent-based scratch-off material and the water-based scratch-off material substantially abut one another without leaving blank space therebetween.

6. The ticket of claim 1, wherein the water-based material is provided in a plurality of locations atop the indicia, and not in a single contiguous location.

7. The ticket of claim 2, wherein the water-based material is further applied at least atop a portion of the substrate where there is no underlying game data or validation information.

8. A pack of lottery tickets, comprising:
a first set of tickets comprising a plurality of ticket substrates having indicia thereon, with the indicia on each of the plurality of ticket substrates including at least game data in a first location on the substrate and validation data in a second location on the substrate, with a solvent-based scratch-off material applied atop at least a portion of the game data on each of the plurality of ticket substrates and a water-based scratch-off material applied atop at least a portion of the validation information on each of the plurality of ticket substrates; and
a second set of tickets comprising a plurality of ticket substrates having indicia thereon, with the indicia on each of the plurality of ticket substrates including at least game data in a primary location on the substrate and validation data in a secondary location on the substrate, with a solvent-based scratch-off material applied atop at least a portion of the game data on each of the plurality of ticket substrates and a water-based scratch-off material applied atop at least a portion of the validation information on each of the plurality of ticket substrates, and wherein the secondary location on the second set of tickets is different from the second location on the first set of tickets.

9. The pack of lottery tickets of claim 8 wherein the first and second set of tickets are for the same lottery game.

10. A ticket, comprising:
a substrate;
indicia provided on the substrate;
a seal layer provided over the indicia on the substrate;
a varnish provided on the seal layer; and
a first scratch-off layer provided on the varnish, the first scratch-off layer comprising in part a solvent-based scratch-off material and further comprising in part a water-based scratch-off material.

11. The ticket of claim 10 further including a second scratch-off layer provided on the first scratch-off layer, the second scratch-off layer comprising in part a solvent-based scratch-off material and further comprising in part a water-based scratch-off material.

12. The ticket of claim 11 wherein the solvent-based scratch-off material and the water-based scratch-off material of the second scratch-off layer substantially overlie the solvent-based scratch-off material and the water-based scratch-off material of the first scratch-off layer, respectively.

13. The ticket of claim 10 wherein the solvent-based scratch-off material and the water-based scratch-off material of the first scratch-off layer is opaque.

14. The ticket of claim 11 wherein the solvent-based scratch-off material and the water-based scratch-off material of the second scratch-off layer is white.

15. The ticket of claim 10 wherein the seal layer and the varnish are clear.

16. A method of producing at least one instant lottery ticket, comprising:
printing indicia onto a substrate;
printing a solvent-based scratch-off material atop at least a portion of the indicia; and
printing a water-based scratch-off material atop at least a portion of the indicia.

17. The method of claim 16 wherein the steps of printing the solvent-based scratch-off material and printing the water-based scratch-off material are performed such that the solvent-based scratch-off material and the water-based scratch-off material comprise a single layer on the ticket.

18. The method of claim 1$ wherein the solvent-based scratch-off material and the water-based scratch-off material substantially abut one another without bleeding into one another.

19. The method of claim 16 wherein the solvent-based scratch-off material and the water-based scratch-off material substantially abut one another without leaving blank space therebetween.

20. The method of claim 16 wherein the water-based material is provided in a plurality of locations atop the indicia, and not in a single contiguous location.

21. The method of claim 20 wherein the water-based material is provided in the form of a word or symbol and not in the form of a geometric shape.

22. The method of claim 16 wherein the step of printing the indicia includes printing at least game data and validation information, and wherein the water-based material is printed at least atop a portion of the validation information as well as atop a portion of the substrate where there is no underlying indicia.

23. The method of claim 16 including the production of a plurality of tickets, wherein the indicia include at least game data and validation information, wherein at least a first of the plurality of tickets includes validation information in a first location on the ticket, and wherein at least a second of the plurality of tickets includes validation information in a second location on the ticket, wherein the first location is different from the second location, and further wherein the water-based scratch-off material is provided above the first location on the first ticket and above the second location on the second ticket.

24. A device for producing instant lottery tickets, comprising:
at least one printer;
a computer having a processor and a memory;
one or more programs stored in the memory and executable by the processor for providing instructions to the at least one printer, wherein the instructions comprise at least the steps of:
printing indicia onto a substrate;
printing a solvent-based scratch-off material atop at least a portion of the indicia; and
printing a water-based scratch-off material atop at least a portion of the indicia.

25. The device of claim 24, wherein the instructions further comprise the steps of printing a seal layer above the indicia and printing a varnish above the seal layer, prior to printing the solvent-based material and the water-based material.

26. The device of claim 24, wherein the step of printing indicia on the substrate includes printing game data and validation information.

27. The device of claim 26 wherein the step of printing indicia includes printing validation information in a first location on one or more tickets, and further printing validation information in a second location different from the first location on one or more tickets.

28. The device of claim 24 wherein the steps of printing the solvent-based material and the water-based material are performed such that the solvent-based scratch-off material and the water-based scratch-off material comprise a single layer on the ticket.

29. The device of claim 24 wherein the solvent-based scratch-off material and the water-based scratch-off material substantially abut one another without bleeding into one another.

30. The device of claim 24 wherein the solvent-based scratch-off material and the water-based scratch-off material substantially abut one another without leaving blank space therebetween.

31. The device of claim 24 wherein the water-based material is provided in a plurality of locations atop the indicia, and not in a single contiguous location.

32. The device of claim 26 wherein the water-based material is printed at least atop a portion of the validation information as well as atop a portion of the substrate where there is no underlying indicia.

33. A ticket, comprising:
a substrate;
indicia provided on the substrate;
a seal layer provided over the indicia on the substrate;
a varnish provided on the seal layer;
a scratch-off layer provided on the varnish; and
a graphic overprint layer provided atop the scratch-off layer.

34. The ticket of claim 33, wherein the scratch-off layer comprises in part a solvent-based scratch-off material and in part a water-based scratch-off material.

35. The ticket of claim 33, further including a benday pattern layer provided either directly above or directly below the indicia.

36. The ticket of claim 33, wherein the indicia provided on the substrate is provided with a benday pattern layer that is printed simultaneously with the indicia on the substrate.

37. The ticket of claim 33, wherein the varnish comprises multiple material types providing for different release characteristics when at least a portion of the scratch-off layer is removed.
